(19) United States
(12) Patent Application Publication
(10) Pub. No.: US 2008/0294526 A1
(43) Pub. Date: Nov. 27, 2008

(54) System and Method for Interrelating Alternative Media-Type Commerce Transactions

(75) Inventors: Jonathan A. Berkowitz, Austin, TX (US); Christopher G. Hyams, Austin, TX (US)

Correspondence Address: HAMILTON & TERRILE, LLP, P.O. BOX 203518, AUSTIN, TX, 78720, US

(73) Assignee: B-Side Entertainment, Inc.

(21) Appl. No.: 12/124,564

(22) Filed: May 21, 2008

Related U.S. Application Data
(60) Provisional application No. 60/939,176, filed on May 21, 2007.

(51) Int. Cl. G06Q 30/00; G06Q 20/00; G06F 17/00

(52) U.S. Cl. 705/20; 705/26; 705/400; 705/16

(57) ABSTRACT

A system and method for interrelating alternative media-type commerce transactions allow a consumer to select and purchase an A/V product having a particular media-type and track the purchase and the media-type. The system and method include different pricing schemes for each A/V product and each media-type. Each A/V product is associated with a pricing scheme that interrelates pricing for purchases by the same consumer of the same A/V product for multiple media-types. In at least one embodiment, the system allows the consumer to make a second purchase of the A/V product and select an alternative media-type. In at least one embodiment, the first and second products have the same content form and a non-discounted price of the second selected product is higher than a non-discounted price of a first selected product.

### CROSS-REFERENCE TO RELATED APPLICATION

This application claims the benefit under 35 U.S.C. §119(e) and 37 C.F.R. §1.78 of U.S. Provisional Application No. 60/939,176, filed May 21, 2007 and entitled “System and Method for Interrelating Alternative Media-Type Commerce Transactions.” U.S. Provisional Application No. 60/939,176 includes exemplary systems and methods and is incorporated by reference in its entirety.

### BACKGROUND OF THE INVENTION

1. Field of the Invention

The present invention relates in general to the field of information processing, and more specifically to a system and method for interrelating alternative media-type commerce transactions.

2. Description of the Related Art

Distributors, retailers, online services (collectively “distributors”) regularly sell or rent (collectively a “commerce transaction”) images, video (including film and sequential “still” images), audio, and audio visual products (collectively referred to as “A/V” products) recordings to consumers. Consumers can choose from a variety of physical media and formats. For example, consumers can choose to purchase video recorded in physical media such as single and multi-layered Digital Video Disc (DVD), Blu-Ray Disc, and High Definition—Digital Video Disc (HD-DVD). Physical media also includes electronic or optical signals (collectively referred to as “electromagnetic signals”) that convey digital files. The digital files can be offered as, for example, downloads and/or streaming video. Consumers can also choose to purchase audio recorded in a variety of physical media such as Compact Disks (“CD) and electromagnetic signals, such as digital file downloads and streaming audio. The foregoing types of physical media represent only a subset of currently available types of physical media and the particular types of physical media continue to expand.

A/V products are available in a variety of different formats. The available image formats include Joint Photographics Expert Group (“JPEG”), JPEG 2000, lossless JPEG, Joint Bi-level Image Experts Group (“JBIG”), JBIG2, Portable Network Graphics (“PNG”), Wireless Application Protocol Bitmap (“WBMP”). The available video formats include Motion Pictures Expert Group (“MPEG)-1, MPEG-2 (commonly used for DVD's), MPEG-3, and MPEG-4 formats and Windows Media Video (“wmv”) format. The available video formats include MPEG-1 Layer III (MP3), MPEG-1 Layer II, MPEG-1 Layer I, AAC, HE-AAC, Windows Media Audio (“wma”), Audio Interchange File Format (“AIFF”), and wave form audio (“wav”) formats. The foregoing formats represent only a subset of currently available formats and the particular formats continue to expand.

The conventional process for commercially distributing A/V products allows a consumer to select the particular A/V product, the type of physical media, and the A/V file format. The physical media and the A/V file format are collectively referred to herein as the “media-type”). For example, a user of a web site that commercially sells A/V products, such as the web site of Wal-Mart, allow the user to select a particular A/V product. A user also selects the media-type of the A/V product. Selection of the media-type can be explicit by actively selecting the type of physical media and the format or can be implicit. For example, in some circumstances, selection of the file format is implied by the selection of the type of physical media or the data format is associated with a default format. For example, selection of an A/V product recorded on a DVD is also a selection of the DVD format.

In general, from a distributor's perspective, a sale of an A/V product having one particular media-type to a consumer is unrelated to sale to the same consumer of the same A/V product having a different media-type. This creates frustration in the marketplace. It forces the consumer to make at least two decisions at purchase time, namely:
What A/V product to I want?; and
Where/how do I want to use it? (for example, with a television, a computer, a portable audio and/or video device, or other playback device).

The first decision is straightforward. The second decision is necessitated by several considerations, such as what type of physical medium is compatible with the intended playback device. The second decision can also be impacted by cost because the cost of different media-types can vary due to, for example, manufacturing costs and delivery costs. Additionally, some types of physical media often have different features. For example, a DVD A/V product may have special features that are unavailable in a digital download file.

Film distributors and others who profit from sales of the A/V product have strong incentives to promote sales of higher priced A/V products because of higher profit margins. Accordingly, lower cost media-types, such as digital download files, are generally given secondary consideration. For example, Amazon.com Inc. of Washington offers higher priced A/V products at a particular price via their “Unbox” service. If a consumer purchases a higher priced A/V product, in at least some instances Amazon.com offers a free digital download file of the higher priced A/V product. This appears to be a proper strategy for attracting consumers and generating higher profit margins.

Some industries, notably the software industry, often sell a product and encourage a consumer to upgrade to a more expensive product. For example, a software company may sell a ‘light’ version of a particular software product and offer a discounted price to the consumer if the consumer will upgrade to a ‘full’ version of the product. In this instance, the media-type of the software product is the same and the software is executed using the same platform without having to use different applications to, for example, decode the two different versions of the software.

### SUMMARY OF THE INVENTION

In at least one embodiment, a method includes receiving a selection of a first product having a first media-type, wherein the product includes data having a first content form. The method further includes receiving a selection of a second product having a second media-type, wherein the second product includes data having the first content form and determining a discounted price of the second product based upon at least a commerce transaction involving the first product, wherein a non-discounted price of the second product is higher than a non-discounted price of the first product. The method also includes providing the price of the second product.

In another embodiment of the present invention, a computer readable medium includes code encoded thereon and executable by one or more processors for
receiving a selection of a first product having a first media-type, wherein the product includes data having a first content form;
receiving a selection of a second product having a second media-type, wherein the second product includes data having the first content form;
determining a discounted price of the second product based upon at least a commerce transaction involving the first product, wherein a non-discounted price of the second product is higher than a non-discounted price of the first product; and
providing the price of the second product.

In a further embodiment of the present invention, an apparatus includes means for receiving a selection of a first product having a first media-type, wherein the product includes data having a first content form. The apparatus also includes means for receiving a selection of a second product having a second media-type, wherein the second product includes data having the first content form. The apparatus also includes means for determining a discounted price of the second product based upon at least a commerce transaction involving the first product, wherein a non-discounted price of the second product is higher than a non-discounted price of the first product. The apparatus further includes means for providing the price of the second product.

In another embodiment of the present invention, a method for interrelating commerce of video sales having different media-types includes receiving, from a user via a network, a selection of a first video product, wherein the first video product includes a video and the first video product has a first media-type. The method also includes identifying the user, receiving, from the user, a selection of a second video product, wherein the second video product includes the video and the second video product has a second media-type, and calculating a price of the second video product based upon a sale of the first video product, wherein a non-discounted price of the second product is higher than a non-discounted price of the first product. The method further includes providing the price of the second video product to the user.

In another embodiment of the present invention, an apparatus includes means for receiving a selection of a first product having a first media-type, wherein the product includes data having a first content form. The apparatus also includes means for receiving a selection of a second product having a second media-type, wherein the second product includes data having the first content form and means for determining a discounted price of the second product based upon at least a commerce transaction involving the first product, wherein a non-discounted price of the second product is higher than a non-discounted price of the first product. The apparatus further includes means for providing the price of the second product.

In a further embodiment of the present invention, method for interrelating commerce of video sales having different media-types includes receiving, from a user via a network, a selection of a first video product, wherein the first video product includes a video and the first video product has a first media-type. The method also includes identifying the user, receiving, from the user, a selection of a second video product, wherein the second video product includes the video and the second video product has a second media-type, and calculating a price of the second video product based upon a sale of the first video product, wherein a non-discounted price of the second product is higher than a non-discounted price of the first product. The method further includes providing the price of the second video product to the user.

In another embodiment of the present invention, a system includes a processor. The system also includes a memory, coupled to the processor, having code stored therein and executable by the processor for:
receiving a selection of a first product having a first media-type, wherein the product includes data having a first content form;
receiving a selection of a second product having a second media-type, wherein the second product includes data having the first content form;
determining a discounted price of the second product based upon at least a price of the first product, wherein a non-discounted price of the second product is higher than a non-discounted price of the first product; and
providing the price of the second product.

In a further embodiment of the present invention, a computer readable media includes code encoded thereon and executable by at least one processor for:
receiving, from a user via a network, a selection of a first video product, wherein the first video product includes a video and the first video product has a first media-type;
identifying the user;
receiving, from the user, a selection of a second video product, wherein the second video product includes the video and the second video product has a second media-type;
calculating a price of the second video product based upon a sale of the first video product, wherein a non-discounted price of the second product is higher than a non-discounted price of the first product; and
providing the price of the second video product to the user.

In another embodiment of the present invention, a system includes a processor. The system also includes a memory, coupled to the processor, having code stored therein and executable by the processor for:
receiving, from a user via a network, a selection of a first video product, wherein the first video product includes a video and the first video product has a first media-type;
identifying the user;
receiving, from the user, a selection of a second video product, wherein the second video product includes the video and the second video product has a second media-type;
calculating a price of the second video product based upon a sale of the first video product, wherein a non-discounted price of the second product is higher than a non-discounted price of the first product; and
providing the price of the second video product to the user.

In a further embodiment of the present invention, an apparatus for interrelating commerce of video sales having different media-types includes means for receiving, from a user via a network, a selection of a first video product, wherein the first video product includes a video and the first video product has a first media-type. The apparatus further includes means for completing a sale of the first video product to the user at a first price and means for identifying the user. The apparatus also includes means for receiving, from the user, a selection of a second video product, wherein the second video product includes the video and the second video product has a second media-type and means for calculating a price of the second video product based upon the sale of the first video product, wherein a non-discounted price of the second product is higher than a non-discounted price of the first product. The apparatus further includes means for providing the price of the second video product to the user.

In another embodiment of the present invention, a method includes receiving a selection of a first audio/video (A/V) product having a first media-type, wherein the first A/V product comprises a movie. The method further includes receiving a selection of a second A/V product having a second media-type, wherein the second A/V product comprises a different movie than the first A/V product and determining a discounted price of the second product based upon at least a commerce transaction involving the first product. The method also includes providing the price of the second product.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an embodiment of a system 100 for interrelating alternative media-type commerce transactions.

FIG. 2 depicts a method for interrelating alternative media-type commerce transactions.

FIG. 3 is a block diagram illustrating a network environment in which a system and method for interrelating alternative media-type commerce transactions may be practiced.

FIG. 4 depicts a general purpose computer system.

FIG. 5 depicts an example interface for interrelating alternative media-type commerce transactions.

### DETAILED DESCRIPTION

A system and method for interrelating alternative media-type commerce transactions allow a consumer to select and purchase an audio/visual (A/V) product having a particular media-type and track the purchase and the media-type. The system and method include different pricing schemes for each A/V product and each media-type. Each A/V product is associated with a pricing scheme that interrelates pricing for purchases by the same consumer of the same A/V product for multiple media-types. In at least one embodiment, the system allows the consumer to make a second purchase of the A/V product and select an alternative media-type. Thus, the system also allows a customer to select a first product having a first media-type, select a second product having a second media type, and determine a discounted price of the second product based upon a commerce transaction involving the first product. In at least one embodiment, the first and second products have the same content form and a non-discounted price of the second selected product is higher than a non-discounted price of a first selected product. The media-type is, for example, the physical media and the A/V file format. The content form of an A/V product is, for example, an image, audio, video, or audio/video product, and the media-type is for example, the type of physical medium that records the content form of the product and the format of the content form.

In at least one embodiment, the system and method free a consumer of the high cost of purchasing the same A/V product in multiple media-types while increasing the likelihood that consumers will purchase the A/V product in a media-type that preserves acceptable profit margins for A/V product distributors. In at least one embodiment, the system and method interrelate pricing of different media-types for the same A/V product. For example, a consumer who purchases an A/V product in a DVD media-type can receive a discounted price for the same A/V product in a less expensive media-type, such as an MPEG-4 digital file download. Additionally, the consumer who purchases an A/V product in a lower cost media-type can receive a discounted price for the same A/V product in a more expensive media-type.

A/V products are available in a variety of media-types. The media-types include the physical medium of the A/V product and the format of the A/V product as previously discussed. In at least one embodiment, the system and method free consumers from having to choose between alternative media types when purchasing an A/V product. The A/V products are offered via multiple media-types such as digital movie files formatted for portable video players, digital movie files formatted for viewing on computers, digital movie files formatted for viewing on large screen televisions or via video projector, digital movie files formatted to burn to digital video disc or other physical media, and via digital streaming protocols over the internet or other digital delivery network. The system and method allow a consumer to select and purchase an A/V product having a particular media-type and track the purchase and the media-type. The system and method include different pricing schemes for each A/V product and each media-type. Each A/V product is associated with a pricing scheme that interrelates pricing for purchases by the same consumer of the same A/V product for multiple media-types. Thus, the system also allows the consumer to make a second purchase of the A/V product and select an alternative media-type.

The system and method determines the price of the second purchase using the pricing schemes. Since the pricing schemes interrelate pricing, the price of the second purchase can be discounted based upon the price of the first purchase price of the A/V product. In at least one embodiment, the A/V products in the first and second purchases are the same in that each A/V product includes the same A/V data, but each A/V product may also include additional A/V data. The content form of the A/V product is, for example, an image, audio, video, or audio/video product, and the media-type is for example, the type of physical medium that records the content form of the product and the format of the content form.

Thus, in at least one embodiment, the system and method include a process, system, and economic model to free consumers from having to choose between alternative media types when purchasing film. The films are offered for sale via any number of physical media alternatives including but not limited to, Digital Video Disc (DVD), Blu-Ray Disc, High Definition—Digital Video Disc (HD-DVD). The films are simultaneously offered for sale via a collection of digital download alternatives including but not limited to digital movie files formatted for portable video players, digital movie files formatted for viewing on computers, digital movie files formatted for viewing on large screen televisions or via video projector, digital movie files formatted to burn to digital video disc or other physical media. The films are also simultaneously offered for sale via digital streaming protocols over the internet or other digital delivery network. A pricing scheme is developed for each film that sets price points for different media alternatives.

Consumers may purchase the film on any media alternative, at its associated price point and receive all cheaper media alternatives for a discount, including free. Consumers may purchase the film, on any media alternative, at its associated price point and use the funds spent on the purchase towards an upgrade to higher priced media alternatives (including a full discount). In at least one embodiment, consumers may purchase the film, on any media alternative, at its associated price point and use the funds spent on the purchase towards a lower priced media alternative (including a full discount).

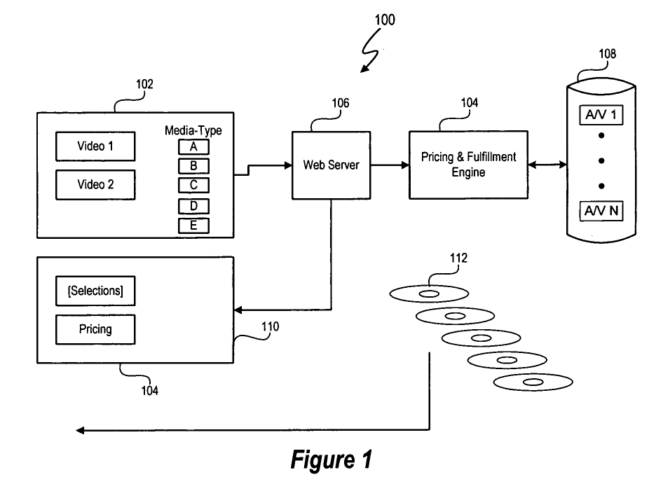

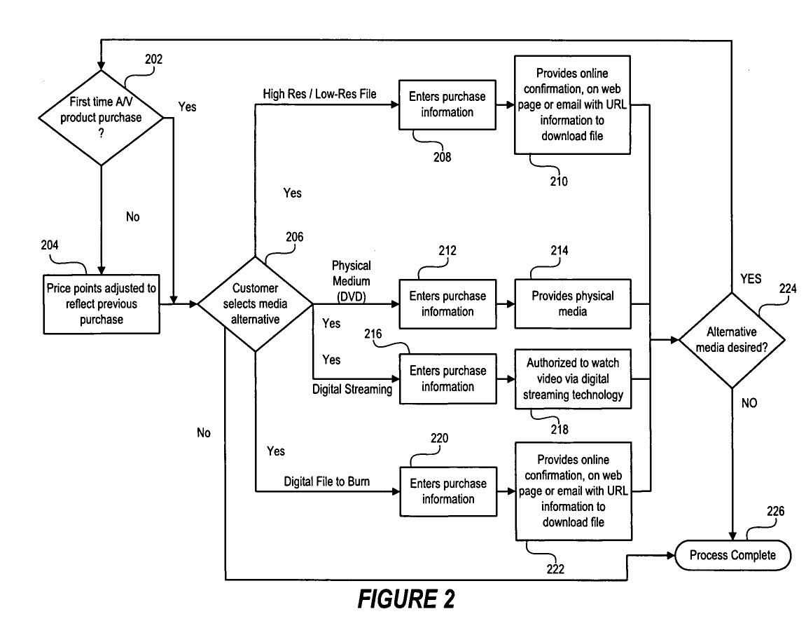

FIG. 1 depicts an embodiment of a system 100 for interrelating alternative media-type commerce transactions. FIG. 2 depicts a method for interrelating alternative media-type commerce transactions. In at least one embodiment, system 100 operates in accordance with method 200. In at least one embodiment, method 200 is embodied in a software program referred to as pricing and fulfillment engine 104.

The system 100 provides a consumer a web page 102 for display on a computer system (not shown) of a consumer. The web server 106 generates web pages, transmits the web pages to a data processing device, and receives response from the device. The data processing device is, for example, a personal computer system, a personal digital assistant, or any other device capable of displaying web pages or rendering content derived from web pages. In at least one embodiment, the web server is connected to a network to facilitate exchange of information. The system 100 also is able to identify return consumers through a cookie and/or through login data and tracks previous A/V product purchases and the purchased media-type.

Upon receiving the web page 102, the consumer has a choice of purchasing A/V products Video 1 or Video 2. In other embodiments, the consumer is allowed to search through and access a library of A/V products that can include hundreds, thousands, or more A/V products. The A/V products may include any combination of images, audio, video, and A/V products. The consumer is also presented with a choice of media-types A, B, and C that are applicable for Video 1 and Video 2. In at least one embodiment, the media-types are presented to the consumer for selection after the consumer selects Video 1 or Video 2. In at least one embodiment, the different media-types use multiple different software applications and/or hardware devices to play the A/V products. For example, a DVD A/V product uses a DVD player to play the DVD product and a digital download file uses a media player, such as Windows Media Player by Microsoft Corp., a Real video player, or other software application executing on a data processing system such as a personal computer system, laptop computer, or portable electronic device.

The system 100 receives the consumer's A/V product selection and selection of a media-type. Operation 202 of method 200 determines whether the consumer's A/V product selection is a first time selection of the A/V product. If the consumer has previously selected the A/V product, operation 204 adjusts the prices to reflect the previous purchase. Thus, the pricing and fulfillment engine interrelates pricing for the same A/V product embodied in different media-types.

Table 1 lists prices for Video 1 for four different media-types. In at least one embodiment, the prices in Table 1 are non-discounted prices although the Video 1 can be offered at discounted prices. Operation 204 can adjust the price of the second media-type purchase of Video 1. The prices for subsequent media-type purchases are based upon the previous purchase using any desired pricing algorithm. For example, subtracting the price in Table 1 for the previously purchased media-type(s) from the price of the currently selected media-type and defaulting any negative numbers to zero. In at least one embodiment, operation 204 subtracts a percentage of the prices for previously purchased media-type from the listed price. The non-discounted price of the DVD media-type is higher than the non-discounted price of the all of the other three media-types. Thus, for example, by purchasing one or more digital download media-types, the price of each digital download media-type purchased is deducted from future purchase of the DVD media-type for the same video. In another example, by purchasing the low-resolution portable file of Video 1, operation 204 determines a discounted price of a high-resolution Movie file and/or a DVD of Video 1.

TABLE 1

| A/V Product | Media-Type Alternative | Price |
|---|---|---|
| Video 1 | Digital Video Disc (DVD) | $15.00 |
| Video 1 | High-resolution Movie File | $8.00 |
| Video 1 | Low-resolution portable file | $4.00 |
| Video 1 | One-time Streaming video | $1.00 |

If the current media-type purchase for the selected A/V product is the first purchase of the A/V product for the consumer or operation 204 has completed, operation 206 determines whether the consumer has selected an alternative media-type (i.e. a media-type different than a previous selection). If the consumer has not selected an alternative media-type, method 200 is complete, and system 100 completes the commercial transaction using, for example, the price depicted in Table 1 for the selected media-type. If the consumer selects an alternative media type, operation 206 determines the media-type selected and causes the fulfillment and pricing engine 104 to perform appropriate processing.

Method 200 depicts five possible media type selections, i.e. high resolution (“High Res”) digital file, low resolution (“Low Res”) digital file, physical medium DVD, digital streaming, and digital file to burn. If the consumer selects a high resolution or low resolution digital file, operation 208 enters the purchase information into database 108 for subsequent use by operations 202 and 204. Operation 210 provides an online purchase and selection confirmation, via, for example, a web page or an e-mail, to the consumer. The online confirmation 110 to the consumer with information on how to download Video 1. The information can include a uniform resource locator (URL) that exchanges information with web server 102 or another web server with access to digital file A/V products. In at least one embodiment, the digital files are stored in database 108 and are available for download to the consumer's data processing device.

If the consumer selected a media-type having a physical medium such as a DVD, operation 212 enters the purchase information into database 108 for subsequent use by operations 202 and 204. Operation 214 processes the purchase information so that the physical medium 112 is provided to the consumer. The physical medium can be delivered via the mail, the medium can be available for pickup, or, if the system 100 is located at a store, a clerk or electronic distribution device can provide the medium to the consumer.

If the consumer selected a digital streaming media-type, operation 216 enters the purchase information into database 108 for subsequent use by operations 202 and 204. Operation 218 provides the consumer with data that provides an authorization to watch the streaming Video 1 via, for example, digital streaming technology.

If the consumer selected a digital file to burn media-type, operation 220 enters the purchase information into database 108 for subsequent use by operations 202 and 204. Operation 222 provides an online purchase and selection confirmation, via, for example, a web page or an e-mail, to the consumer. The online confirmation 110 to the consumer with information on how to download Video 1 in a digital file to burn media-type.

Operation 224 then submits a follow-on inquiry to the consumer to determine if the consumer desires to select an alternative medium for the selected A/V product. If “yes”, method 200 returns to operation 202. Otherwise, method 202 is completed 226.

Method 200 can be modified in any number of ways to facilitate a commercial transaction and delivery flow for any media-type and any pricing schemes.

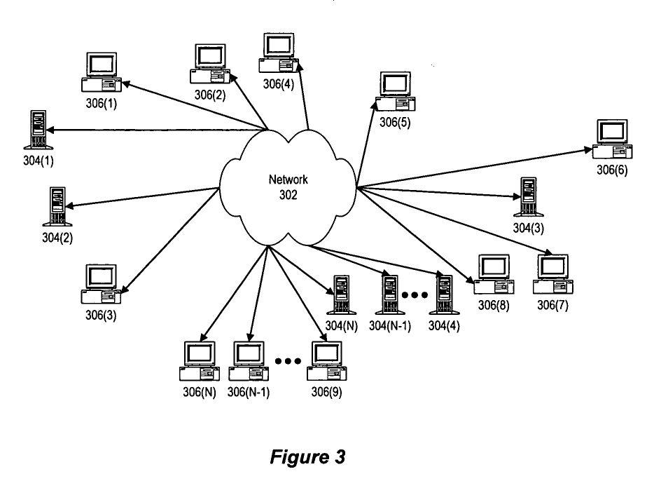

FIG. 3 is a block diagram illustrating a network environment in which a system and method for interrelating alternative media-type commerce transactions may be practiced. Network 302 (e.g. a private wide area network (WAN) or the Internet) includes a number of networked server computer systems 304(1)-(N) that are accessible by client computer systems 306(1)-(N), where N is the number of server computer systems connected to the network. Communication between client computer systems 306(1)-(N) and server computer systems 304(1)-(N) typically occurs over a network, such as a public switched telephone network over asynchronous digital subscriber line (ADSL) telephone lines or high-bandwidth trunks, for example communications channels providing T1 or OC3 service. Client computer systems 306(1)-(N) typically access server computer systems 304(1)-(N) through a service provider, such as an internet service provider (“ISP”) by executing application specific software, commonly referred to as a browser, on one of client computer systems 306(1)-(N).

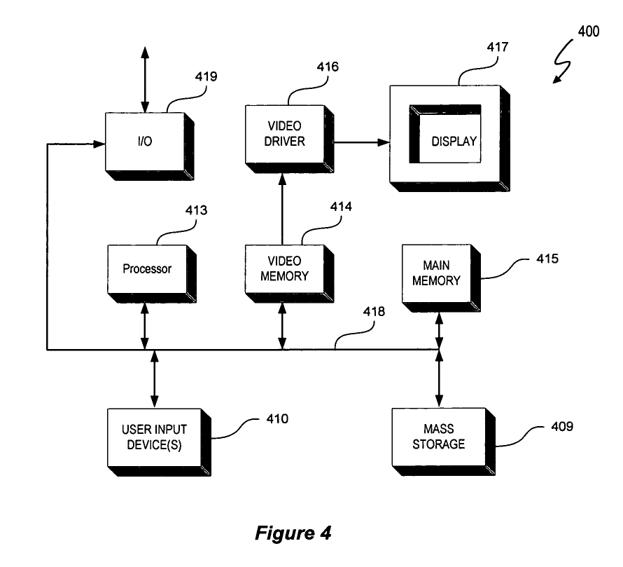

Client computer systems 306(1)-(N) and/or server computer systems 304(1)-(N) may be, for example, computer systems of any appropriate design, including a mainframe, a mini-computer, a personal computer system including notebook computers, a wireless, mobile computing device (including personal digital assistants). These computer systems are typically information handling systems, which are designed to provide computing power to one or more users, either locally or remotely. Such a computer system may also include one or a plurality of input/output (“I/O”) devices coupled to the system processor to perform specialized functions. Mass storage devices such as hard disks, compact disk (“CD”) drives, digital versatile disk (“DVD”) drives, and magneto-optical drives may also be provided, either as an integrated or peripheral device. One such example computer system is shown in detail in FIG. 4.

Embodiments of the system and method for interrelating alternative media-type commerce transactions can be implemented on a computer system such as a general-purpose computer 400 illustrated in FIG. 4. Input user device(s) 410, such as a keyboard and/or mouse, are coupled to a bi-directional system bus 418. The input user device(s) 410 are for introducing user input to the computer system and communicating that user input to processor 413. The computer system of FIG. 4 generally also includes a video memory 414, main memory 415 and mass storage 409, all coupled to bi-directional system bus 418 along with input user device(s) 410 and processor 413. The mass storage 409 may include both fixed and removable media, such as other available mass storage technology. Bus 418 may contain, for example, 32 address lines for addressing video memory 414 or main memory 415. The system bus 418 also includes, for example, an n-bit data bus for transferring DATA between and among the components, such as CPU 409, main memory 415, video memory 414 and mass storage 409, where “n” is, for example, 32 or 64. Alternatively, multiplex data/address lines may be used instead of separate data and address lines.

I/O device(s) 419 may provide connections to peripheral devices, such as a printer, and may also provide a direct connection to a remote server computer systems via a telephone link or to the Internet via an ISP. I/O device(s) 419 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as instructions and data in mass storage 409 until loaded into main memory 415 for execution. Computer programs may also be in the form of electronic signals modulated in accordance with the computer program and data communication technology when transferred via a network.

The processor 413, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 415 is comprised of dynamic random access memory (DRAM). Video memory 414 is a dual-ported video random access memory. One port of the video memory 414 is coupled to video amplifier 416. The video amplifier 416 is used to drive the display 417. Video amplifier 416 is well known in the art and may be implemented by any suitable means. This circuitry converts pixel DATA stored in video memory 414 to a raster signal suitable for use by display 417. Display 417 is a type of monitor suitable for displaying graphic images.

The computer system described above is for purposes of example only. The system and method for interrelating alternative media-type commerce transactions may be implemented in any type of computer system or programming or processing environment. It is contemplated that the system and method for interrelating alternative media-type commerce transactions might be run on a stand-alone computer system, such as the one described above. The system and method for interrelating alternative media-type commerce transactions might also be run from a server computer systems system that can be accessed by a plurality of client computer systems interconnected over an intranet network. Finally, the system and method for interrelating alternative media-type commerce transactions may be run from a server computer system that is accessible to clients over the Internet.

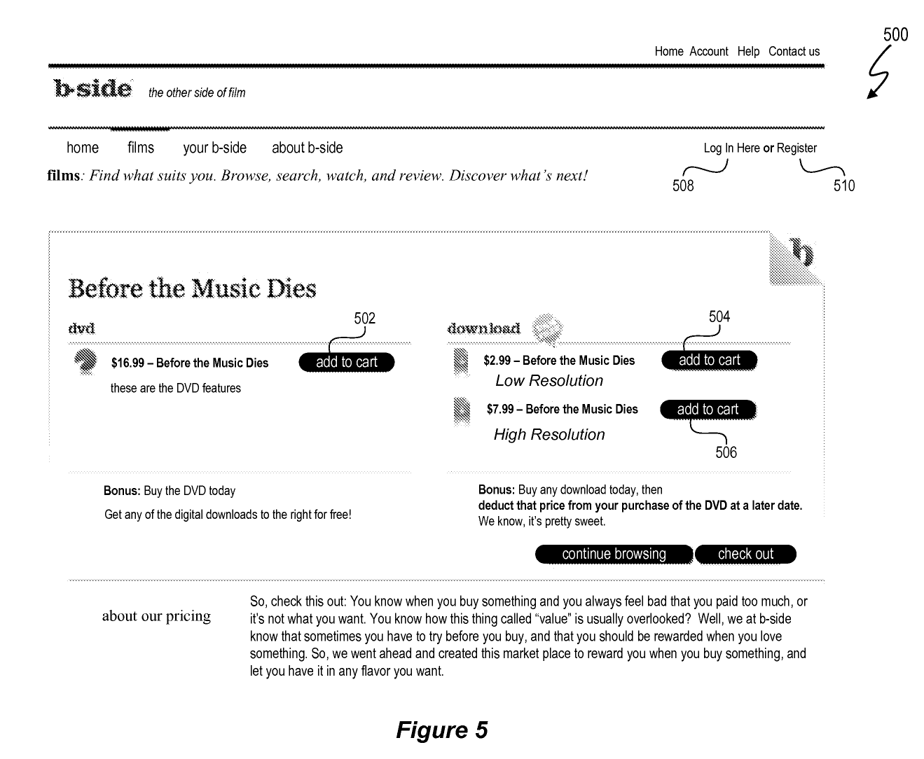

FIG. 5 depicts another example user interface 500 that can be used in addition to or in place of web page 102. User interface 500 an embodied as a web page. The consumer can purchase the A/V product “Before the Music Dies” video in one of three media types. By selecting “add to cart” button 502, the consumer selects the DVD media-type. The consumer can also select a low resolution, digital download media-type of the video by selecting “add to cart” button 504 and/or a high resolution digital download media-type of the video by selecting “add to cart” button 506. The pricing of the DVD and the digital download media-types are interrelated. In at least one embodiment, a textual description of the pricing interrelationship is stated on the user interface 500. By purchasing the DVD, the consumer can receive the digital download media-types for free. By purchasing one or more digital download media-types, the price of each digital download media-type purchased is deducted from future purchase of the DVD media-type for the same video. A consumer preferably logs-in or registers with system 100 by selecting respective button 508 or 510. Logging in and registering provides an example mechanism that allows system 100 and method 200 to track the consumer selections and purchases and perform appropriate, interrelated pricing calculations.

Although the present invention has been described in detail, it should be understood that various changes, substitutions and alterations can be made hereto without departing from the spirit and scope of the invention as defined by the appended claims.

What is claimed is:

1. A method comprising:
receiving a selection of a first product having a first media-type, wherein the product includes data having a first content form;
receiving a selection of a second product having a second media-type, wherein the second product includes data having the first content form;
determining a discounted price of the second product based upon at least a commerce transaction involving the first product, wherein a non-discounted price of the second product is higher than a non-discounted price of the first product; and
providing the price of the second product.

2. The method of claim 1 further comprising completing the commerce transaction involving the first product and receiving a selection of the second product further comprises receiving the selection of the second product having the second media-type after receiving the selection of the first product.

3. The method of claim 1 wherein the data included in the second product includes the data included in the first product.

4. The method of claim 1 wherein the data included in the first product includes the data included in the second product.

5. The method of claim 1 wherein the data included in the first product and the data included in the second product comprise a movie.

6. The method of claim 1 wherein the first content form is a member of a group consisting of: an image, audio, video, or audio/video.

7. The method of claim 1 wherein the first media-type is a member of the group consisting of: digital versatile disk (DVD) format, digital data having a first resolution, and digital data having a second resolution, digital data having a first format, digital data having a second format, a physical DVD medium, and a physical compact disk medium.

8. The method of claim 1 wherein determining a discounted price of the second product further comprises subtracting a price of the first product from a non-discounted price of the second product.

9. The method of claim 1 further comprising:
determining a price of the first product; and
wherein determining a discounted price of the second product based upon at least the commerce transaction involving the first product further comprises determining a discounted price of the second product based upon at least the price of the first product.

10. The method of claim 1 further comprising:
completing a sale of the first and second products.

11. The method of claim 1 wherein determining a discounted price of the second product further comprises:
retrieving a price of the first product from a memory;
determining one or parameters associated with the selection of the second product; and
calculating the price of the second product based upon at least the price of the first product and the one or more parameters associated with the selection of the second product.

12. The method of claim 11 wherein the one or more parameters comprise at least one member of the group consisting of: time between selection of the first product and selection of the second product.

13. The method of claim 1 further comprising:
providing the first product and the second product to a consumer via a member of a group consisting of: a network download and mail delivery.

14. The method of claim 1 wherein the first content form is a member of the group consisting of: video, audio, and a combination of audio and visual forms.

15. A computer readable medium comprising code encoded thereon and executable by one or more processors for:
receiving a selection of a first product having a first media-type, wherein the product includes data having a first content form;
receiving a selection of a second product having a second media-type, wherein the second product includes data having the first content form;
determining a discounted price of the second product based upon at least a commerce transaction involving the first product, wherein a non-discounted price of the second product is higher than a non-discounted price of the first product; and
providing the price of the second product.

16. The computer readable medium of claim 15 wherein the code is further configured for completing the commerce transaction involving the first product and the code for receiving a selection of the second product is further configured for receiving the selection of the second product having the second media-type after receiving the selection of the first product.

17. The computer readable medium of claim 15 wherein the data included in the second product includes the data included in the first product.

18. The computer readable medium of claim 15 wherein the data included in the first product includes the data included in the second product.

19. The computer readable medium of claim 15 wherein the data included in the first product and the data included in the second product comprise a movie.

20. The computer readable medium of claim 15 wherein the first media-type is a member of the group consisting of: digital versatile disk (DVD) format, digital data having a first resolution, and digital data having a second resolution, digital data having a first format, digital data having a second format, a physical DVD medium, and a physical compact disk medium.

21. The computer readable medium of claim 15 wherein the code for determining a discounted price of the second product is configured for subtracting the price of the first product from a non-discounted price of the second product.

22. The computer readable medium of claim 15 wherein the price of the first product is a member of the group consisting of a standard retail price and a price previously provided to a consumer of the first product and second product.

23. The computer readable medium of claim 15 wherein the code for determining a discounted price of the second product further is further configured for:
retrieving the price of the first product from a memory;
determining one or parameters associated with the selection of the second product; and
calculating the price of the second product based upon at least the price of the first product and the one or more parameters associated with the selection of the second product.

24. The computer readable medium of claim 15 wherein the one or more parameters comprise at least one member of the group consisting of: time between selection of the first product and selection of the second product.

25. The computer readable medium of claim 15 wherein the code is further configured for:
providing the first product and the second product to a consumer via network download.

26. The computer readable medium of claim 15 wherein the code is further configured for:
providing the first product and the second product to a consumer via mail delivery.

27. The computer readable medium of claim 15 wherein the first content form is a member of the group consisting of: video, audio, and a combination of audio and visual forms.

28. An apparatus comprising:
means for receiving a selection of a first product having a first media-type, wherein the product includes data having a first content form;
means for receiving a selection of a second product having a second media-type, wherein the second product includes data having the first content form;
means for determining a discounted price of the second product based upon at least a commerce transaction involving the first product, wherein a non-discounted price of the second product is higher than a non-discounted price of the first product; and
means for providing the price of the second product.

29. A method for interrelating commerce of video sales having different media-types, the method comprising:
receiving, from a user via a network, a selection of a first video product, wherein the first video product includes a video and the first video product has a first media-type;
identifying the user;
receiving, from the user, a selection of a second video product, wherein the second video product includes the video and the second video product has a second media-type;
calculating a price of the second video product based upon a sale of the first video product, wherein a non-discounted price of the second product is higher than a non-discounted price of the first product; and
providing the price of the second video product to the user.

30. The method of claim 29 further comprising completing the sale of the first video product and receiving, from the user, the selection of the second video product further comprises receiving, from the user, the selection of the second video product after receiving the selection of the first product.

31. The method of claim 29 wherein the data included in the second product includes the data included in the first product.

32. The method of claim 29 wherein the data included in the first product includes the data included in the second product.

33. The method of claim 29 wherein the data included in the first product and the data included in the second product comprise a movie.

34. The method of claim 29 wherein the first media-type is a member of the group consisting of: digital versatile disk (DVD) format, digital data having a first resolution, and digital data having a second resolution, digital data having a first format, digital data having a second format, a physical DVD medium, and a physical compact disk medium.

35. The method of claim 29 wherein calculating a price of the second product further comprises subtracting a price of the first product from a non-discounted price of the second product.

36. A system comprising:
a processor, and
a memory, coupled to the processor, having code stored therein and executable by the processor for:
receiving a selection of a first product having a first media-type, wherein the product includes data having a first content form;
receiving a selection of a second product having a second media-type, wherein the second product includes data having the first content form;
determining a discounted price of the second product based upon at least a price of the first product, wherein a non-discounted price of the second product is higher than a non-discounted price of the first product; and
providing the price of the second product.

37. The system of claim 36 wherein the code is further configured for completing a commerce transaction involving the first product and the code for receiving a selection of the second product is further configured for receiving the selection of the second product having the second media-type after receiving the selection of the first product.

38. The system of claim 36 wherein the data included in the second product includes the data included in the first product.

39. The system of claim 36 wherein the data included in the first product includes the data included in the second product.

40. The system of claim 36 wherein the data included in the first product and the data included in the second product comprise a movie.

41. The system of claim 36 wherein the first media-type is a member of the group consisting of: digital versatile disk (DVD) format, digital data having a first resolution, and digital data having a second resolution, digital data having a first format, digital data having a second format, a physical DVD medium, and a physical compact disk medium.

42. The system of claim 36 wherein the code for determining a discounted price of the second product is configured for subtracting the price of the first product from a non-discounted price of the second product.

43. The system of claim 36 wherein the price of the first product is a member of the group consisting of a standard retail price and a price previously provided to a consumer of the first product and second product.

44. The system of claim 36 wherein the code for determining a discounted price of the second product further is further configured for:
retrieving the price of the first product from a memory;
determining one or parameters associated with the selection of the second product; and
calculating the price of the second product based upon at least the price of the first product and the one or more parameters associated with the selection of the second product.

45. The system of claim 36 wherein the one or more parameters comprise at least one member of the group consisting of: time between selection of the first product and selection of the second product.

46. The system of claim 36 wherein the code is further configured for:
providing the first product and the second product to a consumer via network download.

47. The system of claim 36 wherein the code is further configured for:
providing the first product and the second product to a consumer via mail delivery.

48. The system of claim 36 wherein the first content form is a member of the group consisting of: video, audio, and a combination of audio and visual forms.

49. A computer readable media having code encoded thereon and executable by at least one processor for:
receiving, from a user via a network, a selection of a first video product, wherein the first video product includes a video and the first video product has a first media-type;
identifying the user;
receiving, from the user, a selection of a second video product, wherein the second video product includes the video and the second video product has a second media-type;
calculating a price of the second video product based upon a sale of the first video product, wherein a non-discounted price of the second product is higher than a non-discounted price of the first product; and
providing the price of the second video product to the user.

50. The computer readable media of claim 49 wherein the code is further configured for completing the sale of the first video product and the code for receiving, from the user, the selection of the second video product is further configured for receiving, from the user, the selection of the second video product after receiving the selection of the first product.

51. The computer readable media of claim 49 wherein the first media-type is a member of the group consisting of: digital versatile disk (DVD) format, digital data having a first resolution, and digital data having a second resolution, digital data having a first format, digital data having a second format, a physical DVD medium, and a physical compact disk medium.

52. The computer readable media of claim 49 wherein calculating a price of the second product further comprises subtracting a price of the first video product from a non-discounted price of the second video product.

53. A system comprising:
a processor, and
a memory, coupled to the processor, having code stored therein and executable by the processor for:
receiving, from a user via a network, a selection of a first video product, wherein the first video product includes a video and the first video product has a first media-type;
identifying the user;
receiving, from the user, a selection of a second video product, wherein the second video product includes the video and the second video product has a second media-type;
calculating a price of the second video product based upon a sale of the first video product, wherein a non-discounted price of the second product is higher than a non-discounted price of the first product; and
providing the price of the second video product to the user.

54. The system of claim 53 wherein the code is further configured for completing the sale of the first video product to the user at a first price and the code for receiving a selection of the second product is further configured for receiving, from the user, the selection of the second video product, wherein the second video product includes the video and the second video product has the second media-type after receiving the selection of the first product.

55. The system of claim 53 wherein the first media-type is a member of the group consisting of: digital versatile disk (DVD) format, digital data having a first resolution, and digital data having a second resolution, digital data having a first format, digital data having a second format, a physical DVD medium, and a physical compact disk medium.

56. The system of claim 53 wherein calculating a price of the second video product further comprises subtracting a price of the first video product from a non-discounted price of the second video product.

57. An apparatus for interrelating commerce of video sales having different media-types, the apparatus comprising:
means for receiving, from a user via a network, a selection of a first video product, wherein the first video product includes a video and the first video product has a first media-type;
means for completing a sale of the first video product to the user at a first price;
means for identifying the user;
means for receiving, from the user, a selection of a second video product, wherein the second video product includes the video and the second video product has a second media-type;
means for calculating a price of the second video product based upon the sale of the first video product, wherein a non-discounted price of the second product is higher than a non-discounted price of the first product; and
means for providing the price of the second video product to the user.

58. A method comprising:
receiving a selection of a first audio/video (A/V) product having a first media-type, wherein the first A/V product comprises a movie;
receiving a selection of a second A/V product having a second media-type, wherein the second A/V product comprises a different movie than the first A/V product;
determining a discounted price of the second product based upon at least a commerce transaction involving the first product; and
providing the price of the second product.

59. The method of claim 58 further comprising completing the commerce transaction involving the first product and receiving a selection of the second product further comprises receiving the selection of the second product having the second media-type after receiving the selection of the first product.

60. The method of claim 58 wherein a non-discounted price of the second product is higher than a non-discounted price of the first product.
